(19) United States
(12) Patent Application Publication
(10) Pub. No.: US 2017/0262038 A1
(43) Pub. Date: Sep. 14, 2017

(54) SMART DEVICE AND SWAP METHOD

(71) Applicant: FUJITSU LIMITED, Kawasaki-shi (JP)

(72) Inventor: Masaaki Noro, Kawasaki (JP)

(73) Assignee: FUJITSU LIMITED, Kawasaki-shi (JP)

(21) Appl. No.: 15/414,092

(22) Filed: Jan. 24, 2017

(30) Foreign Application Priority Data
Mar. 10, 2016 (JP) 2016-047254

(51) Int. Cl. G06F 1/32; G06F 9/44

(52) U.S. Cl. CPC G06F 1/329; G06F 9/4418; G06F 9/4403

(57) ABSTRACT

A non-saving-subject process list creator creates a non-saving-subject process list on the basis of a list of processes in execution and a setting information storage unit. A saving-subject memory list creator then creates a saving-subject memory block list on the basis of the non-saving-subject process list. The data saving unit then saves the data in the swap area on the basis of the saving-subject memory block list.

### CROSS-REFERENCE TO RELATED APPLICATION(S)

This application is based upon and claims the benefit of priority of the prior Japanese Patent Application No. 2016-047254, filed on Mar. 10, 2016, the entire contents of which are incorporated herein by reference.

### FIELD

The embodiments discussed herein are related to a smart device and a swap method.

### BACKGROUND

The period of the idle mode of a smart device, such as a smartphone or a smart watch, is longer than the time during which the smart device runs. For example, a smartwatch runs in limited occasions, for example, when the smartwatch is notified of an event by a smartphone or when the user changes the setting, and is in the idle mode in the remaining period. FIG. 16 is a diagram for explaining operations of a smartwatch.

As illustrated in FIG. 16, for example, when a smartwatch 8 in a BLE (Bluetooth (trademark) low energy) standby idle mode receives an event from a smartphone 9, the smartwatch 8 notifies a user of the event by using, for example, vibration or LED light. The smartwatch 8 performs an operation of, for example, transferring the e-mail message according to an operation of the user and then returns to the idle mode.

As described above, the period of the idle mode of a smart device is long and therefore reducing the power consumption during the idle mode enables extension of the running time of the buttery. For this reason, there is a technology for causing transition of the mode of a smart device from the idle mode to the hibernation mode. FIG. 17 is a diagram for explaining reduction of the power consumption by using hibernation.

As illustrated in FIG. 17, while the power consumption increases when a smart device is in an active mode, the period of the active mode is shorter than the period of the idle mode. For this reason, lowering the power consumption in the idle mode by using hibernation enables reduction of the power consumption of the smart device. In FIG. 17, “idle mode power (old)” represents the power consumption in the idle mode in a case where hibernation is not performed and “idle mode power (new)” represents the power consumption in the idle mode in a case where hibernation is performed.

In order to cause transition of the mode of the smart device to the hibernation mode, it is needed to save the data in the central processing unit (CPU) and the memory and to restore the saved data when the smart device enters the active mode. FIG. 18 is a diagram for explaining saving and restoring of data on transition of the mode.

As illustrated in FIG. 18, the smartwatch 8 performs data saving process before transitioning from the active mode to the hibernation mode and, when recovering from the hibernation mode, performs a data recovering process before recovering from the hibernation mode. For this reason, in hibernation, it is important to shorten the time to save data and the time to restore data as much as possible.

There is a technology in which a pre-active mode is provided to a smart device to shorten the restoration process on recovery from the hibernation mode. FIG. 19 is a diagram for explaining the pre-active mode. As illustrated in FIG. 19, the smartwatch 8 transitions to the pre-active mode before transitioning from the hibernation mode to the active mode and then transitions from the pre-active mode to the active mode.

In the saving process on the transition to the hibernation mode, the smartwatch 8 divides data into needed data and unneeded data to restart the user processing on its recovery from the hibernation mode and saves the sets of data in a storage. In other words, the smartwatch 8 saves, in a swap area, the data unneeded to restart the user processing on its recovery from the hibernation mode and saves, in a hibernation area, the data needed to restart the user processing on its recovery from the hibernation mode.

In the restoration process on the recovery from the hibernation mode, the smartwatch 8 restores only the data in the hibernation area and transitions to the pre-active mode. In the pre-active mode, the smartwatch 8 restarts the user processing and restores the data in the swap area by using a swap-in and, when all the data in the swap area is restored, transitions to the active mode.

There is another technology that, when a hibernation starting process is performed, shortens the start-up time by curbing the size of a memory management area to a size needed for kernel initialization and reading a hibernation image in parallel with hardware initialization.

There is still another technology that shortens the processing time on re-powering on by, when power is re-supplied, re-reading, in a main memory, initial start-up data that is saved in a hard disk device by using a hibernation function to enable a start-up in an initial mode.

There is still another technology that shortens the sensory latency time to the user by, on recovery from the hibernation mode, recovering only the operating system (OS) to the running mode in the main memory and then recovering each process on the OS to the running mode.

Patent Document 1: Japanese Laid-open Patent Publication No. 2012-252576

Patent Document 2: Japanese Laid-open Patent Publication No. 2004-38546

Patent Document 3: Japanese Laid-open Patent Publication No. 2010-250512

When the pre-active mode illustrated in FIG. 19 is provided, there is a problem in that it is not possible to identify a memory area whose data is restored from the swap area in the pre-active mode, i.e., a memory area whose data is saved in the swap area on the transition to the hibernation mode. FIG. 20 is a diagram for explaining the problem occurring when a memory area whose data is saved in the swap area on the transition to the hibernation mode is identified.

As illustrated in FIG. 20, the memory area 5 includes an area 5a that is used by the kernel, an area 5b that is used by processes needed to restart the processing, an area 5c that is used by other processes, and a free area. The area where the three areas overlap is a memory area shared among the processes. The hatched area, among the area 5c that is used by other processes, not overlapping the area 5a used by the kernel or the area 5b used by the processes needed to restart the processing is the area unneeded to restart the processing. In other words, the hatched area is the memory area whose data is saved in the swap area on the transition to the hibernation mode.

Identifying the area 5a used by the kernel and the area 5b used by the processes needed to restart the processing among the memory area in use thus makes it possible to identify the area unneeded to restart the processing. When it is possible to additionally install an application as in the case of the smart device, however, it is not possible to identify in advance processes needed to restart the processing and therefore it is not possible to identify the area 5b that is used by the processes needed to restart the processing.

### SUMMARY

According to an aspect of an embodiment, a device includes a memory and a processor coupled to the memory and the processor configured to create a list of processes that are to be executed when user processing is restarted on recovery from a hibernation mode in which power consumption is low; configured to create identification information that identifies a saving area that is obtained by excluding, from an entire memory area of the memory in use, a memory area that is used by the processes included in the list of the processes and a memory area that is used by a kernel of an operating system which is executed by the processor; and configured to save, in a swap area, the data of the memory area that is identified by the identification information created by the second creator.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating transition of the mode of a smart device according to a first embodiment;

FIG. 2 is a diagram of a functional configuration of the smart device according to the first embodiment;

FIG. 3 is a diagram of an exemplary setting information storage unit;

FIG. 4 is a diagram for explaining a method of identifying non-saving-subject processes by using privileged-user IDs and service process IDs;

FIG. 5 is a flowchart of a flow of a process performed by a non-saving-subject process list creator;

FIG. 6 is a flowchart of a flow of a non-saving list creating process;

FIG. 7 is a flowchart of a flow of a process performed by the saving-subject memory list creator;

FIG. 8 is a diagram of a functional configuration of a smart device according to a second embodiment;

FIG. 9 is a flowchart of a flow of a process performed by a non-saving-subject process list creator;

FIG. 10 is a flowchart of a flow of a process performed by a saving-subject memory list creator;

FIG. 11 is a diagram of a functional configuration of a smart device according to a third embodiment;

FIG. 12 is a flowchart of a flow of a process performed by a saving-subject memory list creator;

FIG. 13 is a flowchart of a flow of a process performed by a data saving unit;

FIG. 14 is a diagram for explaining use of a non-volatile memory;

FIG. 15 is a diagram of a hardware configuration of a computer that executes swap programs according to a first to third embodiments;

FIG. 16 is a diagram for explaining operations of a smartwatch;

FIG. 17 is a diagram for explaining reduction of the power consumption by using hibernation;

FIG. 18 is a diagram for explaining data saving and data restoration;

FIG. 19 is a diagram for explaining a pre-active mode; and

FIG. 20 is a diagram for explaining a problem occurring when a memory area whose data is to be restored from the swap area in the pre-active mode is identified.

### DESCRIPTION OF EMBODIMENT(S)

Preferred embodiments of the present invention will be explained with reference to accompanying drawings. Note that the embodiments do not limit the technology disclosed herein.

### [a] First Embodiment

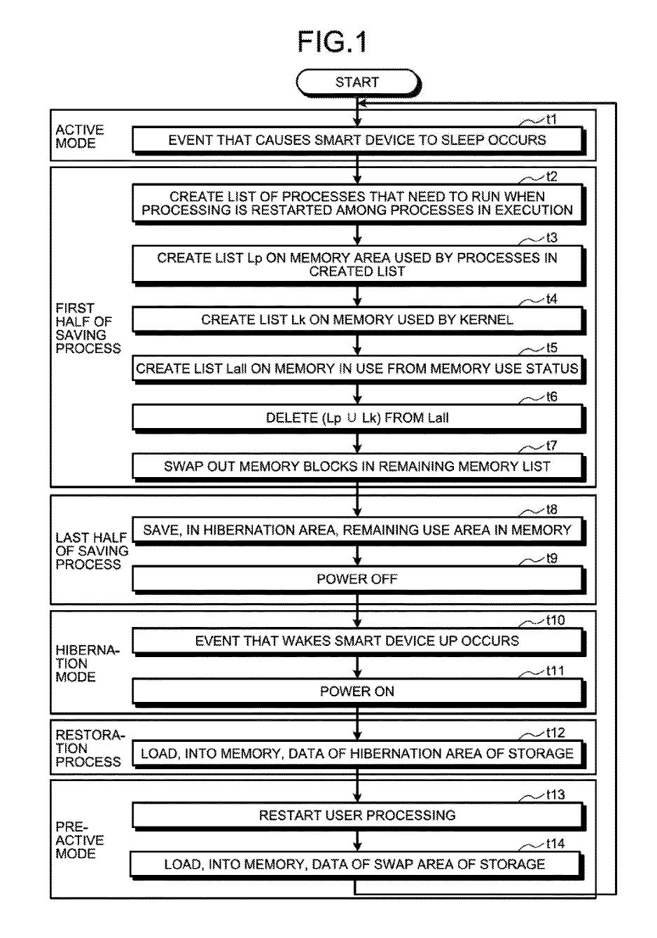

First of all, transition of the mode of a smart device according to a first embodiment will be described. FIG. 1 is a diagram illustrating transition of the mode of the smart device according to the first embodiment. As illustrated in FIG. 1, when an event that causes the smart device in the active mode to sleep occurs (t1), the smart device creates a list of processes that need to run when the processing is restarted among processes in execution in the first half of a saving process (t2).

The smart device then creates a list Lp on the memory area that is used by the processes in the created list (t3). The smart device further creates a list Lk on the memory that is used by the kernel of the OS (t4). The smart device creates a list Lall on the memory in use on the basis of the memory use status (t5) and deletes (Lp∪Lk) from Lall (t6), where (Lp∪Lk) is a sum set of Lp and Lk. The smart device swaps out the remaining memory blocks in the memory list (t7).

In the last half of the saving process, the smart device saves, in a hibernation area, the remaining areas in use in the memory (t8) and powers off (t9). The smart device then transitions to the hibernation mode. When an event that wakes the smart device up occurs (t10), the power turns on (t11).

In a restoration process, the smart device loads the data in the hibernation area in the storage into the memory (t12) and transitions to a pre-active mode. The smart device restarts the user processing (t13) and loads the data in the swap area of the storage into the memory (t14). When loading the data in the swap area into the memory completes, the smart device transitions to the active mode.

As described above, the smart device according to the first embodiment deletes (LP∪Lk) from Lall and swaps out the remaining memory blocks in the memory list in the first half of the saving process and thus is able to create, in the swap area, the data to be restored in the pre-active mode.

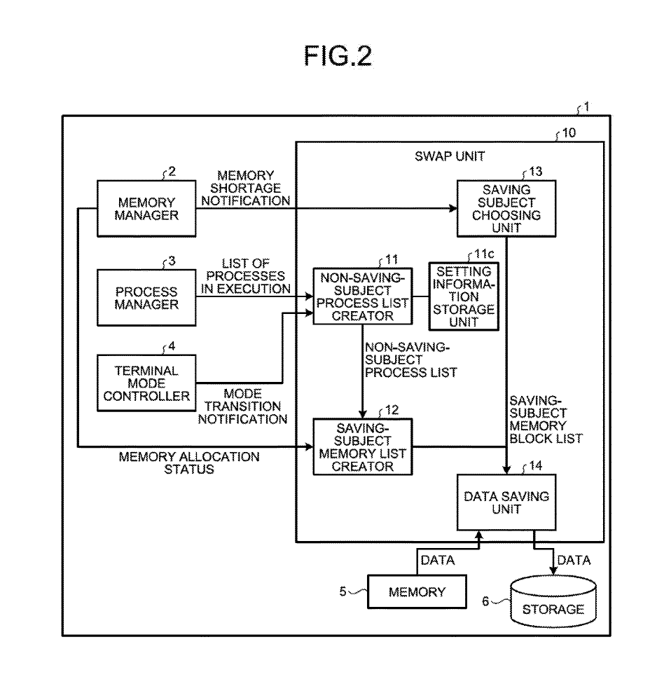

The functional configuration of the smart device according to the first embodiment will be described here. FIG. 2 is a diagram of a functional configuration of the smart device according to the first embodiment. As illustrated in FIG. 2, a smart device 1 includes a memory manager 2, a process manager 3, a terminal mode controller 4, and a swap unit 10.

The memory manager 2 is a module of the OS kernel and manages a memory 5 according to each memory block. The memory manager 2 notifies the swap unit 10 of the memory allocation status according to a request from the swap unit 10. When shortage of the memory 5 occurs, the memory manager 2 notifies the swap unit 10 of the memory shortage.

The process manager 3 is a module of the OS kernel and manages the process. The process manager 3 notifies the swap unit 10 of the list of processes in execution according to a request from the swap unit 10. The list of processes in execution contains information on the parent-child relationship among the processes.

The terminal mode controller 4 manages the mode of the smart device 1. The mode of the smart device 1 includes an active mode, a hibernation mode, and a pre-active mode. On transition of the mode of the smart device 1, the terminal mode controller 4 notifies the swap unit 10 of the mode transition.

The swap unit 10 saves, in a storage 6, the data of the memory 5 by using a swap-out and restores, in the memory 5, the data saved in the storage 6. The swap unit 10 includes a non-saving-subject process list creator 11, a setting information storage unit 11c, a saving-subject memory list creator 12, a saving subject choosing unit 13, and a data saving unit 14.

When notified of the transition to the hibernation mode by the terminal mode controller 4, the non-saving-subject process list creator 11 creates, as a non-saving-subject process list, a list of processes that need to run when the user processing is restarted. The non-saving-subject process list creator 11 acquires the list of processes in execution from the process manager 3 and creates a non-saving-subject process list on the basis of the acquired process list and the setting information storage unit 11c. Note that the non-saving-subject process list is a list of process IDs.

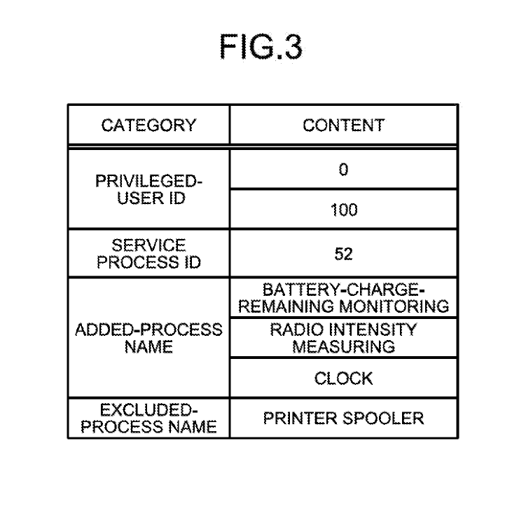

The setting information storage unit 11c stores setting information that is used to create a non-saving-subject process list. As represented in FIG. 3, the setting information storage unit 11c stores the category and the content in association with each other. The category represents the type of setting information. The category includes the privileged-user identifier (ID), the service process ID, the added-process name, and the excluded-process name. The content is information on the process that is associated with the category.

An privileged-user ID is an identifier of an privileged process that runs according to the manager authority. According to FIG. 3, “0” and “100” are privileged-user IDs, and “0” is a manager authorized-user ID, such as an identifier of a route process and “100” is a user ID of an OS module that controls a graphical user interface (GUI) and a database.

A service process ID is an identifier of a service process that runs according to service authority of, for example, system management. According to FIG. 3, “52” is a service process ID, such as a process ID of middleware needed to run the OS.

An added-process name is the name of a process that is added to the non-saving-subject process list among the processes whose identifiers are other than privileged-user IDs and service process IDs. According to FIG. 3, “battery-charge-remaining monitoring”, “radio intensity measuring” and “clock” are the names of added processes.

The excluded-process name is the name of a process that is excluded from the non-saving-subject process list among processes whose identifiers are categorized into an privileged-user ID or a service process ID. According to FIG. 3, “printer spooler” is the name of an excluded process, and “printer spooler” is excluded from the non-saving-subject process list because it is a process that does not need to run when the user processing is restarted.

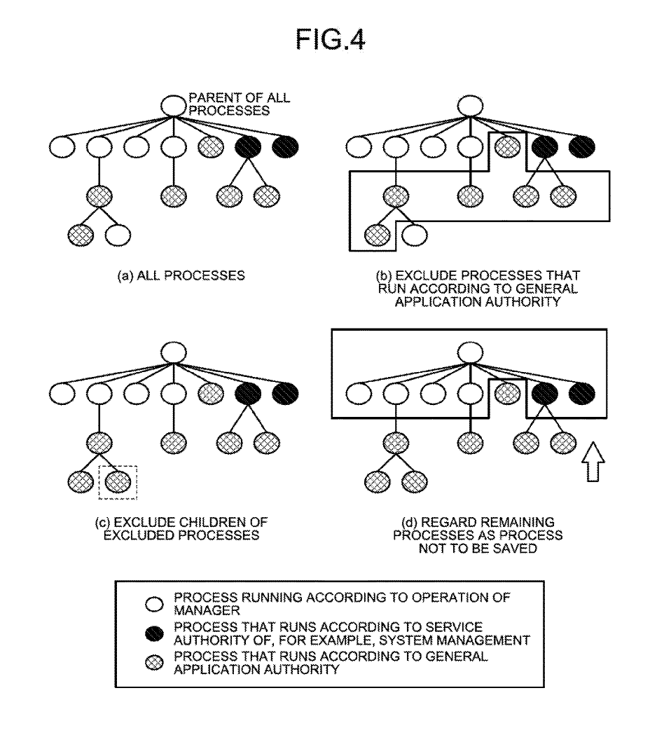

FIG. 4 is a diagram for explaining a method of identifying non-saving-subject processes by using privileged-user IDs and service process IDs. According to FIG. 4, a blank circle represents a privileged process, a filled circle represents a service process, and a hatched circle represents a general process that runs according to another type of general application authority.

The non-saving-subject process list creator 11 acquires the list of processes in execution from the process manager 3 and creates a tree by analyzing the parent-child relationships among the processes. FIG. 4(a) illustrates an exemplary tree that is created by using all the processes in execution.

As illustrated in FIG. 4(b), the non-saving-subject process list creator 11 excludes general processes from the tree that is created by using all the processes in execution. As illustrated in FIG. 4(c), the non-saving-subject process list creator 11 then excludes the children of the excluded general processes. The reason of this is that, because the general processes do not need to run when the user processing is restarted, the processes that are generated from only the general processes do not need to run when the user processing is restarted regardless of their type.

As illustrated in FIG. 4(d), the non-saving-subject process list creator 11 regards the remaining processes as non-saving subject processes.

The non-saving-subject process list creator 11 also excludes the children of general processes from the non-saving-subject processes as described above and thus is able to appropriately identify processes that need to run when the user processing is restarted.

By using the non-saving-subject process list, the saving-subject memory list creator 12 deletes the area being used by the kernel and the processes that need to run when the user processing is restarted from the whole memory area in use and creates a list of memory blocks of a saving area. The saving area is a memory area whose data is saved in the swap area on the transition to the hibernation mode, i.e., a memory area whose data is restored in the pre-active mode after the recovery from the hibernation mode. The saving-subject memory list creator 12 passes the created list as a saving-subject memory block list to the data saving unit 14. The saving-subject memory block list is a list of identifiers that identify memory blocks.

On receiving a memory shortage notification from the memory manager 2, the saving subject choosing unit 13 creates a list of memory blocks whose data is to be saved in the storage 6 and passes the saving-subject memory block list to the data saving unit 14.

On receiving the saving-subject memory block list, the data saving unit 14 saves, in the storage 6, the data of the saving-subject memory blocks from the memory 5.

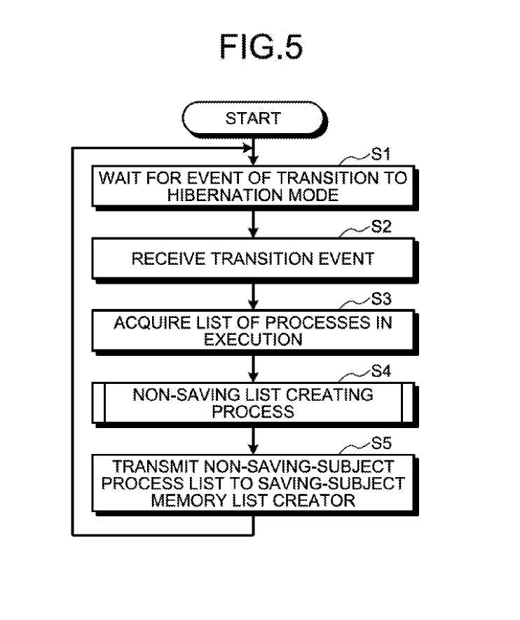

The flow of the process performed by the non-saving-subject process list creator 11 will be described here. FIG. 5 is a flowchart of a flow of the process performed by the non-saving-subject process list creator 11. As illustrated in FIG. 5, the non-saving-subject process list creator 11 waits for an event of transition to the hibernation mode (step S1).

The non-saving-subject process list creator 11 then receives an event of transition to the hibernation mode (step S2) and acquires a list of processes in execution from the process manager 3 (step S3).

The non-saving-subject process list creator 11 performs a non-saving list creating process of creating a non-saving-subject process list (step S4) and transmits the non-saving-subject process list to the saving-subject memory list creator 12 (step S5).

The non-saving-subject process list creator 11 creates the non-saving-subject process list and transmits the non-saving-subject process list to the saving-subject memory list creator 12 as described above and thus the saving-subject memory list creator 12 is able to create the saving-subject memory block list.

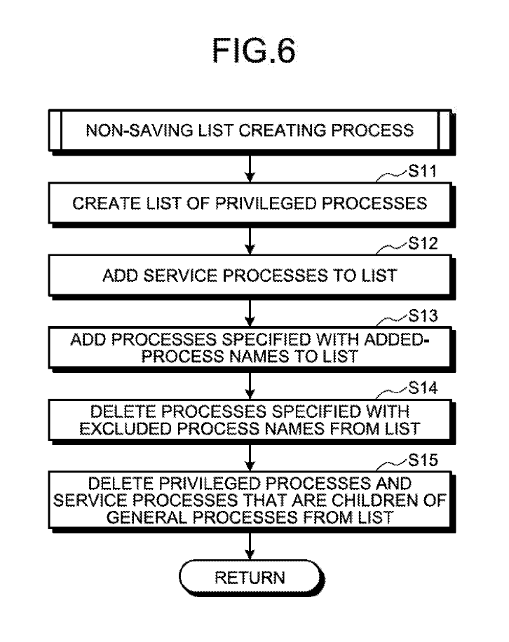

FIG. 6 is a flowchart of a flow of the non-saving list creating process. As illustrated in FIG. 6, the non-saving-subject process list creator 11 refers to the setting information storage unit 11c and creates a list of privileged processes (step S11).

The non-saving-subject process list creator 11 then refers to the setting information storage unit 11c and adds the service processes to the list (step S12). The non-saving-subject process list creator 11 then refers to the setting information storage unit 11c and adds the processes specified by the added-process names (step S13).

The non-saving-subject process list creator 11 refers to the setting information storage unit 11c and deletes the processes specified by the excluded-process names (step S14). The non-saving-subject process list creator 11 analyzes the parent-child relationships among the processes by using the list of processes in execution and accordingly deletes privileged processes and service processes that are children of general processes from the list (step S15).

As described above, when creating a non-saving-subject process list, the non-saving-subject process list creator 11 excludes privileged processes and service processes that are children of general processes from the list. Thus, the non-saving-subject process list creator 11 is able to appropriately identify processes that need to run when the user processing is restarted.

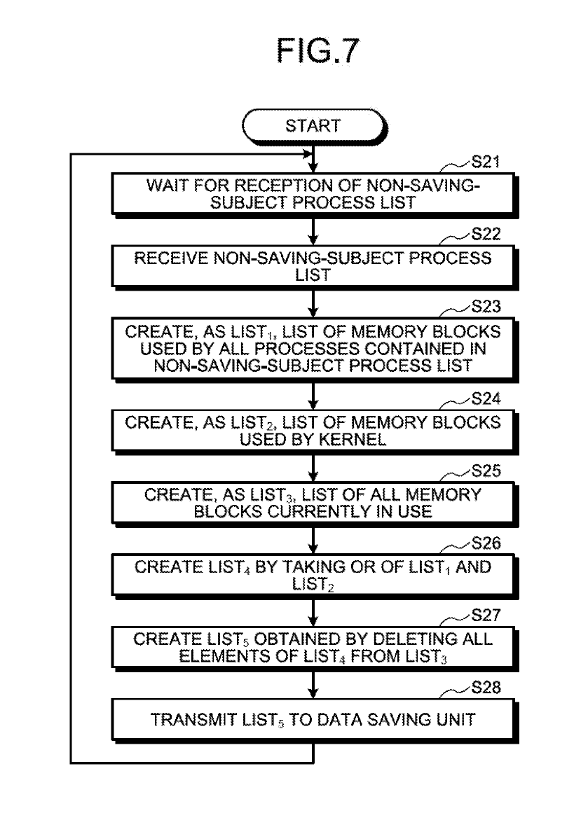

The flow of the process performed by the saving-subject memory list creator 12 will be described. FIG. 7 is a flowchart of the flow of the process performed by the saving-subject memory list creator 12. As illustrated in FIG. 7, the saving-subject memory list creator 12 waits for reception of a non-saving-subject process list (step S21).

On receiving a non-saving-subject process list (step S22), the saving-subject memory list creator 12 creates, as a list₁, a list of memory blocks that are used by all the processes contained in the non-saving-subject process list (step S23). The saving-subject memory list creator 12 then creates a list of memory blocks that are used by the kernel as a list₂ (step S24) and creates a list of all the memory blocks currently in use as a list₃ (step S25).

The saving-subject memory list creator 12 then creates a list₄ by taking OR (logical disjunction) of the list₁ and the list₂ (step S26) and creates a list₅ obtained by deleting all the elements of the list₄ from the list₃ (step S27). The saving-subject memory list creator 12 transmits the list₅ as a saving-subject memory block list to the data saving unit 14 (step S28).

The saving-subject memory list creator 12 creates a saving-subject memory block list as described above and thus the data saving unit 14 is able to save, in the swap area, the data unneeded when the user processing is started.

As described above, in the first embodiment, the non-saving-subject process list creator 11 creates a non-saving-subject process list on the basis of the list of processes in execution and the setting information storage unit 11c. The saving-subject memory list creator 12 then creates a saving-subject memory block list on the basis of the non-saving-subject process list. The data saving unit 14 then saves the data in the swap area on the basis of the saving-subject memory block list.

Accordingly, the smart device 1 is able to identify a memory area whose data is to be saved in the swap area on its transition to the hibernation mode and saves the data of the identified memory area in the swap area. In other words, on its transition to the hibernation mode, the smart device 1 is able to save, in the swap area, the data of an appropriate area of the memory.

In the first embodiment, the non-saving-subject process list creator 11 creates a non-saving-subject process list including privileged processes and service processes. Accordingly, the smart device 1 is able to prevent the data of the memory area used by the processes that need to run when the smart device 1 recovers from the hibernation mode from being saved in the swap area and restart the user processing in the pre-active mode.

In the first embodiment, the non-saving-subject process list creator 11 creates the non-saving-subject process list excluding privileged processes and service processes that run as children of general processes. Accordingly, the smart device 1 is able to accurately identify processes that need to run when the user processing is restarted.

In the first embodiment, the non-saving-subject process list creator 11 creates the non-saving-subject process list by adding or excluding processes of specific names. Accordingly, the smart device 1 is able to appropriately control the processes that need to run when the user processing is restarted.

### [b] Second Embodiment

The smart device 1 that creates a non-saving-subject process list on its transition to the hibernation mode has been described as the first embodiment. The smart device may also keep updating the non-saving-subject process list. A smart device that keeps updating a non-saving-subject process list will be described as a second embodiment.

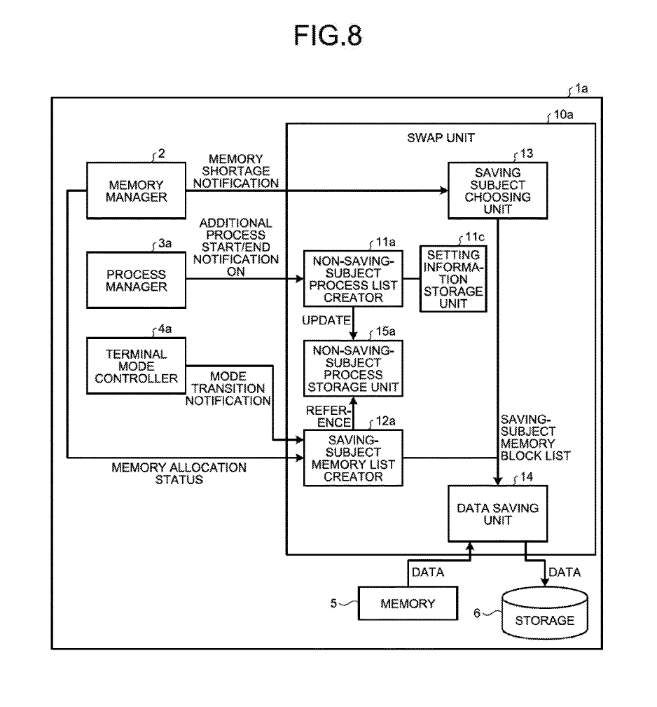

FIG. 8 is a diagram of a functional configuration of the smart device according to the second embodiment. For convenience of description, the functional units that play the same roles as those of the units illustrated in FIG. 2 are denoted with the same reference numbers as those in FIG. 2, and detailed descriptions thereof will be omitted below.

As illustrated in FIG. 8, differently from the smart device 1 illustrated in FIG. 2, a smart device la includes a process manager 3a instead of the process manager 3, includes a terminal mode controller 4a instead of the terminal mode controller 4, and includes a swap unit 10a instead of the swap unit 10.

While the process manager 3a has the same function as that of the process manager 3, the process manager 3a notifies the swap unit 10a of newly starting and ending of processes instead of the list of processes in execution. While the terminal mode controller 4a has the same function as that of the terminal mode controller 4, what is notified of the mode transition differs. Specifically, a saving-subject memory list creator 12a, which will be described below, is notified of the mode transition.

While the swap unit 10a has the same function as that of the swap unit 10, the swap unit 10a includes a non-saving-subject process list creator 11a instead of the non-saving-subject process list creator 11 and includes the saving-subject memory list creator 12a instead of the saving-subject memory list creator 12. The swap unit 10a additionally includes a non-saving-subject process storage unit 15a.

The non-saving-subject process storage unit 15a stores a non-saving-subject process list. On receiving newly starting or ending of a process from the process manager 3a, the non-saving-subject process list creator 11a creates a non-saving-subject process list and updates the non-saving-subject process storage unit 15a. In other words, the non-saving-subject process list creator 11a creates a non-saving-subject process list when a process is newly started or ended.

On being notified of the transition to the hibernation mode by the terminal mode controller 4a, the saving-subject memory list creator 12a refers to the non-saving-subject process storage unit 15a and creates a saving-subject memory block list.

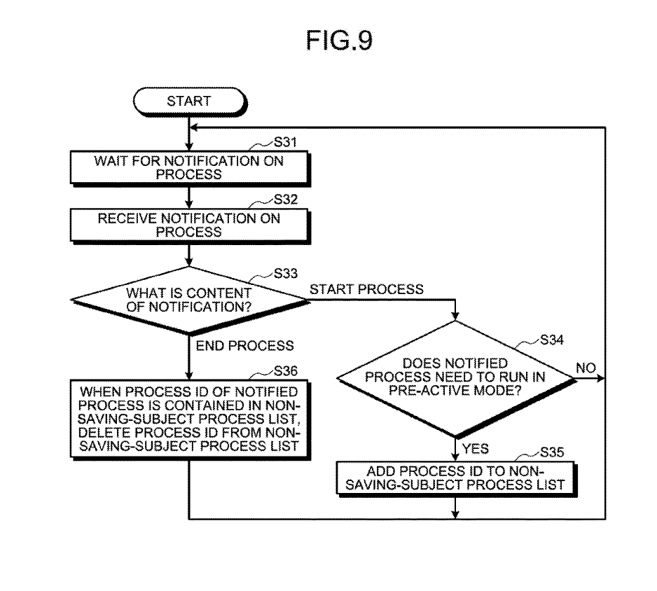

FIG. 9 is a flowchart of a flow of a process that is performed by the non-saving-subject process list creator 11a. As illustrated in FIG. 9, the non-saving-subject process list creator 11a waits for a notification on a process from the process manager 3a (step S31). On receiving the notification on a process (step S32), the non-saving-subject process list creator 11a determines what the content of the notification is (step S33).

As a result, when the notification content is starting of a process, the non-saving-subject process list creator 11a determines whether the notified process needs to run in the pre-active mode (step S34). When the process does not need to run in the pre-active mode, the non-saving-subject process list creator 11a returns to step S31. On the other hand, when the process needs to run in the pre-active mode, the non-saving-subject process list creator 11a adds the process ID to the non-saving-subject process list (step S35), updates the non-saving-subject process storage unit 15a, and returns to step S31.

When the notification content is ending of a process and the process ID of the notified process is contained in the non-saving-subject process list, the non-saving-subject process list creator 11a deletes the process ID from the non-saving-subject process list (step S36). The non-saving-subject process list creator 11a then updates the non-saving-subject process storage unit 15a and returns to step S31.

The non-saving-subject process list creator 11a updates the non-saving-subject process list when a process is started or ended and thus the non-saving-subject process list creator 11a does not need to create a non-saving-subject process list on transition to the hibernation mode.

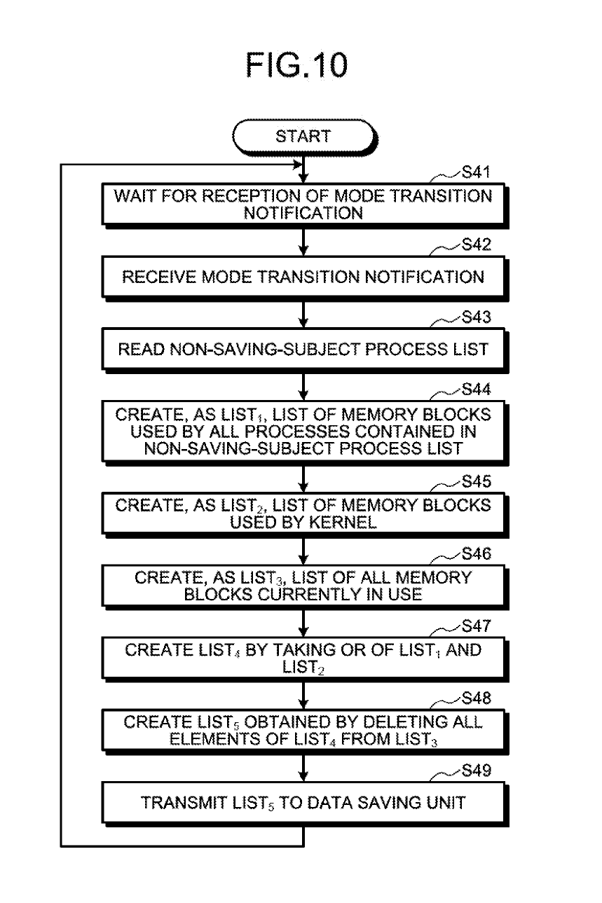

FIG. 10 is a flowchart of a flow of a process performed by the saving-subject memory list creator 12a. As illustrated in FIG. 10, the saving-subject memory list creator 12a waits for reception of a mode transition notification (step S41).

The saving-subject memory list creator 12a then receives a mode transition notification (step S42) and reads the non-saving-subject process list from the non-saving-subject process storage unit 15a (step S43). The saving-subject memory list creator 12a creates, as a list₁, a list of memory blocks that are used by all the processes contained in the non-saving-subject process list (step S44).

The saving-subject memory list creator 12a creates a list of memory blocks that are used by the kernel as a list₂ (step S45) and creates a list of blocks of the entire memory currently in use as a list₃ (step S46).

The saving-subject memory list creator 12a creates a list₄ by taking the OR of the list₁ and the list₂ (step S47) and creates a list₅ obtained by deleting all the elements of the list₄ from the list₃ (step S48). The saving-subject memory list creator 12a transmits the list₅ as a saving-subject memory block list to the data saving unit 14 (step S49).

The saving-subject memory list creator 12a refers to the non-saving-subject process storage unit 15a and creates the saving-subject memory block list and thus the process of creating a non-saving-subject process list is not needed on the transition to the hibernation mode.

As described above, in the second embodiment, the smart device 1a keeps updating the non-saving-subject process list and thus does not need to create a non-saving-subject process list on its transition to the hibernation mode, and accordingly it is possible shorten the time to save data.

### [c] Third Embodiment

The case where the non-saving-subject process list is kept updated has been described as the second embodiment. Furthermore, the saving-subject memory block list may be kept updated. A smart device that keeps updating a saving-subject memory block list will be described as the third embodiment.

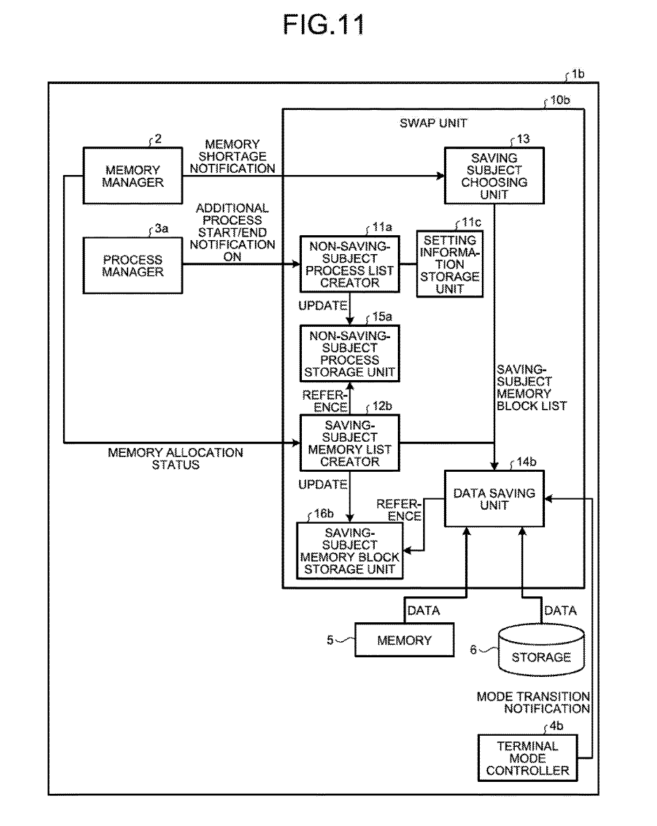

FIG. 11 is a diagram of a functional configuration of the smart device according to the third embodiment. For convenience of description, the functional units that play the same roles as those of the units illustrated in FIG. 8 are denoted with the same reference numbers as those in FIG. 8, and detailed descriptions thereof will be omitted below.

As illustrated in FIG. 11, differently from the smart device 1a illustrated in FIG. 8, a smart device 1b includes a terminal mode controller 4b instead of the terminal mode controller 4a and includes a swap unit 10b instead of the swap unit 10a. While the terminal mode controller 4b has the same function as that of the terminal mode controller 4a, what is notified of the mode transition differs. Specifically, a data saving unit 14b, which will be described below, is notified of the mode transition.

Differently from the swap unit 10a, the swap unit 10b includes a saving-subject memory list creator 12b instead of the saving-subject memory list creator 12a and includes the data saving unit 14b instead of the data saving unit 14. The swap unit 10b additionally includes a saving-subject memory block storage unit 16b.

The saving-subject memory block storage unit 16b stores a saving-subject memory block list. When the non-saving-subject process list is updated, the saving-subject memory list creator 12b refers to the non-saving-subject process storage unit 15a, creates a saving-subject memory block list, and updates the saving-subject memory block storage unit 16b.

While the data saving unit 14b has the same function as that of the data saving unit 14, the data saving unit 14b, on receiving a mode transition notification from the terminal mode controller 4b, refers to the saving-subject memory block storage unit 16b and saves the data of the memory blocks contained in the saving-subject memory block list.

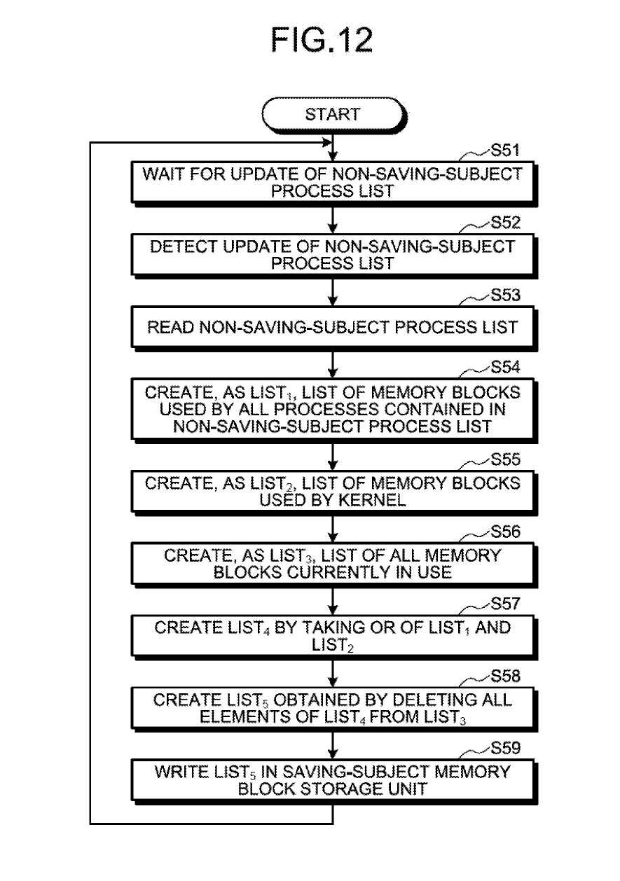

FIG. 12 is a flowchart of a flow of a process performed by the saving-subject memory list creator 12b. As illustrated in FIG. 12, the saving-subject memory list creator 12b waits for an update of the non-saving-subject process list (step S51).

On detecting an update of the non-saving-subject process list (step S52), the saving-subject memory list creator 12b reads the non-saving-subject process list from the non-saving-subject process storage unit 15a (step S53). The saving-subject memory list creator 12b then creates, as a list₁, a list of memory blocks that are used by all the processes contained in the non-saving-subject process list (step S54).

The saving-subject memory list creator 12b creates a list of memory blocks that are used by the kernel as a list₂ (step S55) and creates a list of blocks of the entire memory currently in use as a list₃ (step S56).

The saving-subject memory list creator 12b creates a list₄ by taking OR of the list₁ and the list₂ (step S57) and creates a list₅ obtained by deleting all the elements of the list₄ from the list₃ (step S58). The saving-subject memory list creator 12b writes the list₅ as a saving-subject memory block list to the saving-subject memory block storage unit 16b (step S59).

As described above, when the non-saving-subject process list is updated, the saving-subject memory list creator 12b refers to the non-saving-subject process storage unit 15a, creates a saving-subject memory block list, and writes the saving-subject memory block list in the saving-subject memory block storage unit 16b.

Accordingly, on its transition to the hibernation mode, the smart device 1b does not need the process of creating a saving-subject memory block list.

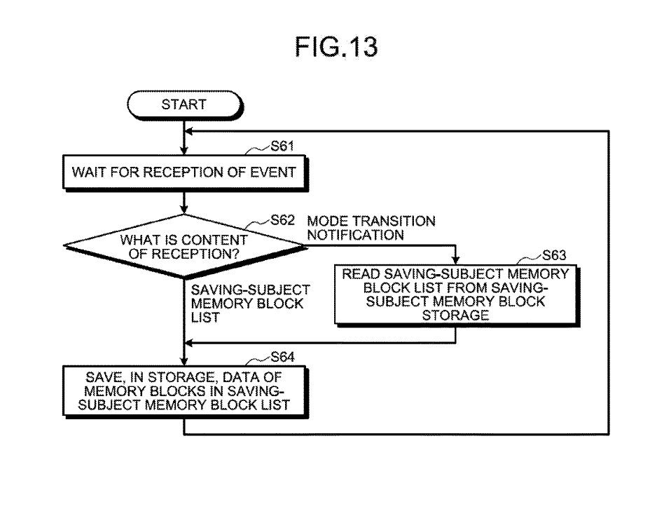

FIG. 13 is a flowchart of a flow of a process performed by the data saving unit 14b. As illustrated in FIG. 13, the data saving unit 14b waits for reception of an event (step S61) and, when an event is received, determines what the content of the reception is (step S62).

As a result, when the content of the reception is a mode transition notification, the data saving unit 14b reads the saving-subject memory block list from the saving-subject memory block storage unit 16b (step S63). The data saving unit 14b then saves, in the storage 6, the data of the memory blocks in the saving-subject memory block list (step S64) and returns to step S61.

On the other hand, when the content of the reception is a saving-subject memory block list, the data saving unit 14b saves, in the storage 6, the data of the memory blocks in the saving-subject memory block list (step S64) and returns to step S61.

The data saving unit 14b reads the saving-subject memory block list from the saving-subject memory block storage unit 16b as described above and thus is able to start saving data immediately.

As described above, in the third embodiment, the smart device 1b keeps updating the saving-subject memory block list and thus is able to further shorten the time to save data on its transition to the hibernation mode.

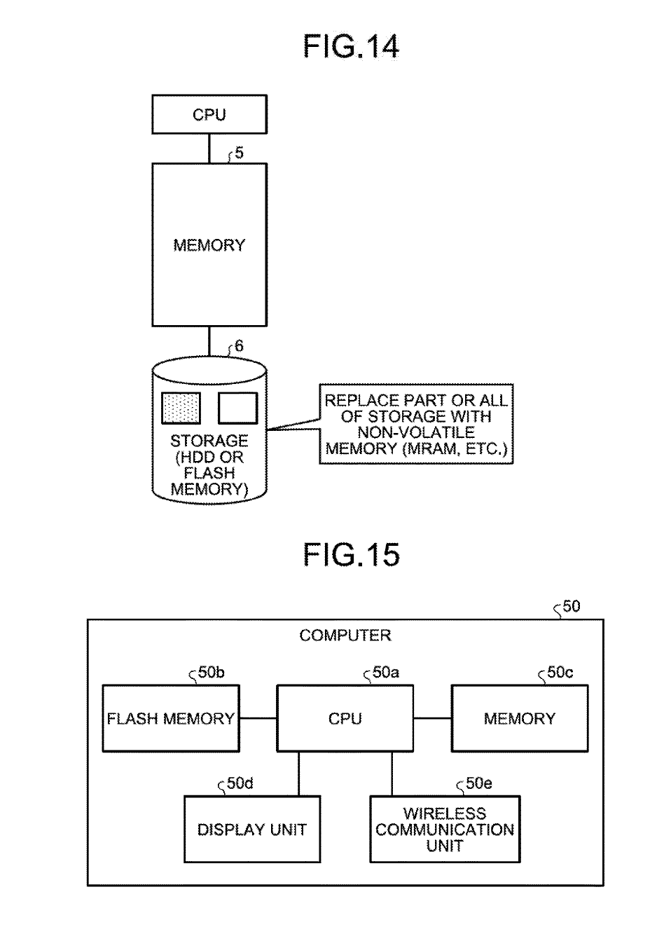

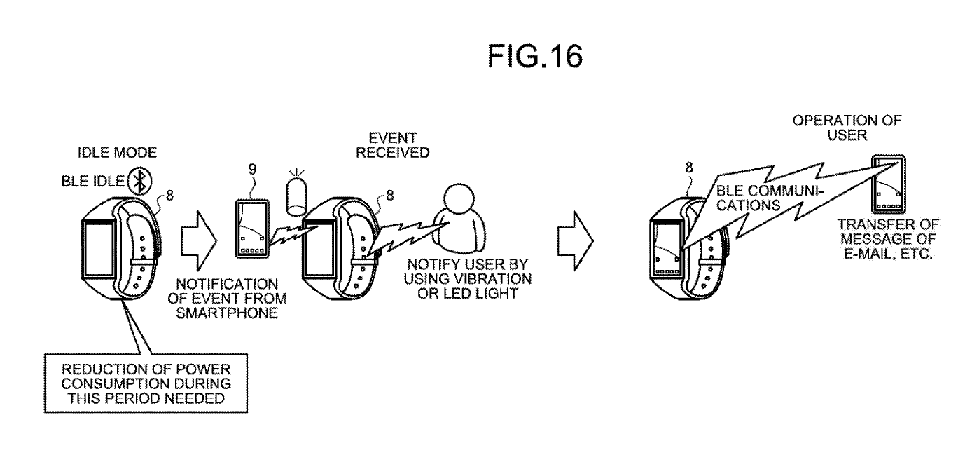

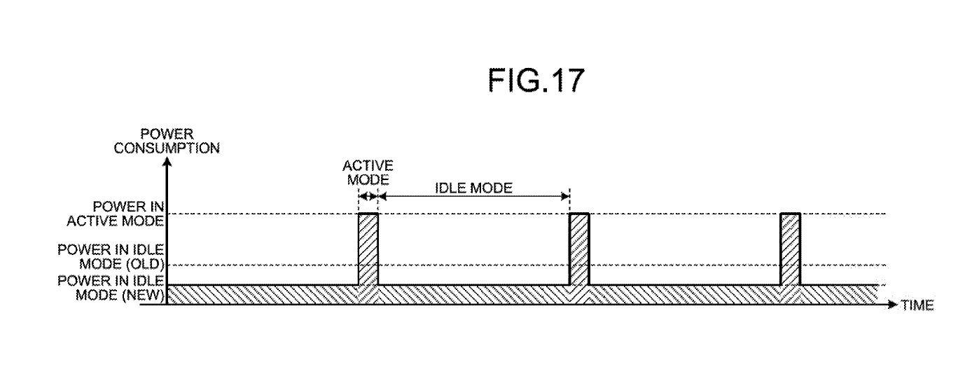

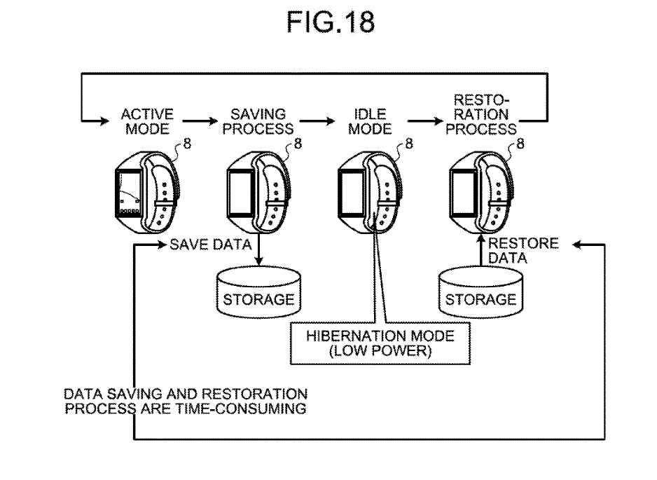

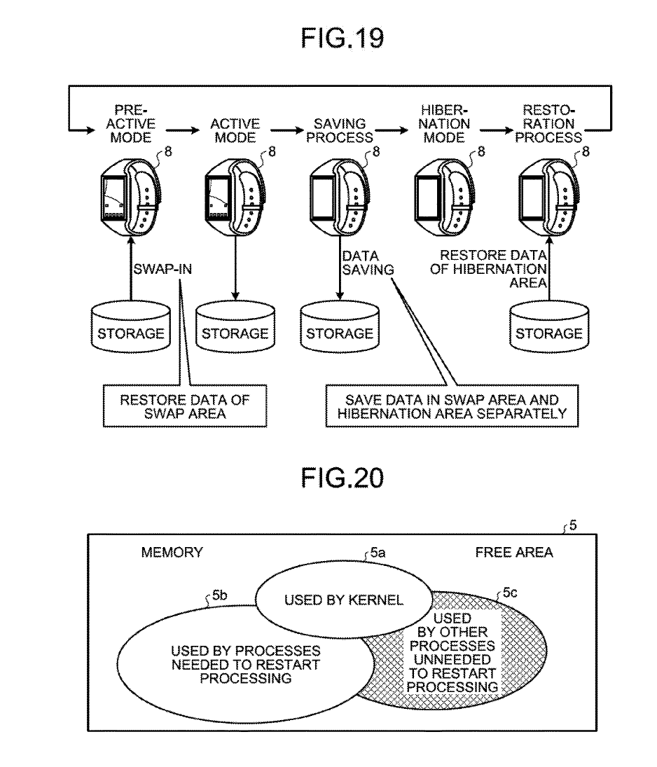

According to the first to third embodiments, the smart device saves data in the storage 6 that is, for example, a flash memory or a hard disk drive (HDD). Note that the storage 6 may be a non-volatile memory, such as a magnetoresistive random access memory (MRAM), as illustrated in FIG. 14.

Alternatively, the storage 6 may be partly a non-volatile memory. For example, a hibernation area may be provided to a MRAM and a swap area may be provided to a flash memory. Providing the hibernation area to the MRAM enables fast transition to the pre-active mode.

The swap units according to the first to third embodiments are implemented by a computer by executing swap programs with the same functions as those of the swap units. The computer that executes the swap programs will be described here.

FIG. 15 is a diagram of a hardware configuration of the computer that executes the swap programs according to the first to third embodiments. As illustrated in FIG. 15, a computer 50 includes a CPU 50a, a flash memory 50b, a memory 50c, a display unit 50d, and a wireless communication unit 50e.

The CPU 50a is a processing device that reads and executes the application and a program, such as the swap program, stored in the memory 50c. The flash memory 50b is a non-volatile memory that stores, for example, the application and the swap program. The flash memory 50b corresponds to the storage 6 illustrated in FIGS. 2, 8 and 11.

The memory 50c is a RAM that stores, for example, the application and the swap program that are read from the flash memory 50b. The memory 50c stores, for example, the data needed to execute the swap program and the intermediate result of execution of the swap program. The memory 50c corresponds to the memory 5 illustrated in FIGS. 2, 8 and 11.

The display unit 50d is a device that displays a screen that is output by the application and is, for example, a liquid crystal display device. The display unit 50d accepts a touch operation of the user and passes the accepted data to the CPU 50a.

The wireless communication unit 50e is a module that performs wireless communications, such as communications via a local area network (LAN), Bluetooth (trademark), and mobile phones. The wireless communication unit 50e may have multiple wireless communication functions.

According to an aspect of the embodiments, it is possible to save, in the swap area, the data of the appropriate area of the memory on transition to the hibernation mode.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A device comprising:
a memory; and
a processor coupled to the memory and the processor configured to:
create a list of processes that are to be executed when user processing is restarted on recovery from a hibernation mode in which power consumption is low;
create identification information that identifies a saving area that is obtained by excluding, from an entire memory area of the memory in use, a memory area that is used by the processes included in the list of the processes and a memory area that is used by a kernel of an operating system which is executed by the processor; and
save, in a swap area, the data of the memory area that is identified by the identification information created by the second creator.

2. The device according to claim 1, wherein the processor configured to create the list of processes including privileged processes that run according to manager authority and service processes that run according to service authority.

3. The device according to claim 2, wherein the processor configured to analyze a parent-child relationship among the privileged processes, the service processes, and general processes that run according to general application authority and creates the list of processes excluding a privileged process and a service process that run as children of the general processes.

4. The device according to claim 2, wherein the processor configured to create the list of processes by adding or excluding a process of a specific name.

5. The device according to claim 1, wherein the processor configured to create the list of processes on transition to the hibernation mode.

6. The device according to claim 1, wherein the processor configured to create the list of processes when a process is generated or ended.

7. The device according to claim 6, wherein the processor configured to create the identification information when the list of processes is created.

8. A swap method for a computer to execute a process comprising:
creating a list of processes that are to be executed when user processing is restarted on recovery from a hibernation mode in which power consumption is low;
creating identification information that identifies a saving area that is obtained by excluding, from an entire memory area of the memory in use, a memory area that is used by the processes included in the list of the processes and a memory area that is used by a kernel of an operating system which is executed by the processor; and
saving, in a swap area, the data of the memory area that is identified by the created identification information.

9. A non-transitory computer-readable storing medium having stored therein a program that causes a computer to execute a process comprising:
creating a list of processes that are to be executed when user processing is restarted on recovery from a hibernation mode in which power consumption is low;
creating identification information that identifies a saving area that is obtained by excluding, from an entire memory area of the memory in use, a memory area that is used by the processes included in the list of the processes and a memory area that is used by a kernel of an operating system which is executed by the processor; and
saving, in a swap area, the data of the memory area that is identified by the created identification information.
